(19) United States
(12) Patent Application Publication
(10) Pub. No.: US 2006/0095523 A1
(43) Pub. Date: May 4, 2006

(54) System and method for sending messages into a communications network by electronic mail, based on the use of a send filter

(76) Inventor: Bruno Decarpigny, Hinges (FR)

Correspondence Address: LADAS & PARRY LLP, 224 SOUTH MICHIGAN AVENUE, SUITE 1600, CHICAGO, IL, 60604, US

(21) Appl. No.: 11/156,278

(22) Filed: Jun. 17, 2005

(30) Foreign Application Priority Data
Nov. 2, 2004 (FR) 04 11657

(51) Int. Cl. G06F 15/16

(52) U.S. Cl. 709/206

(57) ABSTRACT

The present invention relates to a system and a method for sending messages into a communications network by electronic messaging, based on the use of a send filter. As the communications network 1 includes an access server 2 used by a sender terminal 3 for connecting to this network 1 and the sender terminal 3 has access to a list of addresses of terminals, the method of the invention is characterized in that it comprises a configuration step during which a send code is associated with each terminal address contained in the list of addresses, a duplication step during which the list of addresses is duplicated at least once, a modification step during which each list of addresses is changed in order to contain at least one wrong send code, a step for selecting, during the sending of a message to an addressee terminal 4, a list of addresses from the lists of addresses, a step for inserting into the message the send code associated with the address of the addressee terminal in the selected list of addresses, and a step for checking compliance of the send code inserted in the message.

The object of the present invention is a system and method for sending messages into a communications network by electronic mail, based on the use of a send filter, and for limiting propagation of computer viruses and the drawbacks related to unsolicited messages.

Communications networks, such as Internet, give their users access to practically any type of information and allow them to exchange practically any type of information. In particular, with the use of instant messaging systems and mail systems such as electronic mail, commonly called e-mail, transmission and reception of information has become virtually instantaneous. This possibility of directly communicating with a correspondent is of considerable interest for most people, to such an extent that all or nearly all the users of a terminal now have an electronic address allowing them to use an electronic messaging system.

The use of electronic mail is therefore widespread, thereby allowing users to remain in contact more easily, to exchange information more frequently and without much effort.

However, electronic mail has become an efficient vector for propagating computer viruses. Indeed, viruses generally use electronic messaging to propagate from one terminal to the other, within a document attached to the sent message. When the attached document is opened by the addressee, the virus is released and may act.

Viruses are notably known which are capable of scanning the contents of the address book on the terminal on which they are executed and of thereby propagating to all or a part of the terminals, the address of which appears in this address book. So the identity of the victim is thereby fraudulently stolen in order to send an infected message to all the terminals, the address of which is present in the address book of the victim.

Further, certain viruses have been developed which are directly transported by an electronic mail, without their needing to be inserted in an attached document, which makes them difficult to be detected. Upon opening such a message, from an apparently trustworthy sender, but whose identity has been stolen, the addressee will be infected by the virus automatically.

The problem for any user of electronic messaging, notably as a sender of electronic messages, is therefore to have a system which may block the sending of fraudulent messages, often virus carriers, from his/her own terminal.

Most antivirus solutions consist of executing software which scans the contents of the terminal in order to check for the presence of viruses, the signature of which is known. Conventionally, this type of antivirus is only efficient if it is regularly updated so as to be able to detect new viruses or new variants of existing viruses which arrive on the network every week or even every day. Moreover, these antiviruses operate by definition when the virus has physically been downloaded on the terminal on which it executes. Between the moment when the virus arrives on the terminal and the moment when the antivirus software is executed, the virus may have already engaged in action to propagate to other terminals.

Therefore, there is a need for a system and method for sending messages into a communications network by electronic messaging, with which the aforementioned drawbacks may be overcome. Thus, the object of the present invention is to overcome these drawbacks by proposing a solution which limits propagation of viruses by electronic messaging.

The invention according to a first aspect, therefore relates to a method for sending messages into a communications network by electronic messaging, including at least one sender access server. The sender access server is used by at least one sender terminal to connect to the communications network. The sender terminal has access to at least one list of terminal addresses.

The method of the invention is characterized in that it comprises the following steps:

a configuration step during which a send code is associated with each terminal address contained in the list of addresses,

a duplication step during which the list of addresses is duplicated at least once,

a modification step during which each list of addresses is changed in order to contain at least one wrong send code,

a step for selecting, upon sending a message to an addressee terminal, a list of addresses from the lists of addresses,

a step for inserting into the message, the send code associated with the address of the addressee terminal in the selected list of addresses,

a step for checking compliance of the send code inserted into the message.

In an alternative embodiment, the sender terminal has access to at least one security code, and the method of the invention further comprises a step for inserting the security code into the message, and a step for checking compliance of the security code inserted in the message. Preferably, the security code is randomly and periodically set by the access server.

Also preferably, the steps for checking the send code and/or the security code are performed by the access server. When any of the checking steps give a non-compliant result, the access server informs the sender terminal and/or blocks the sending of the message.

In another alternative embodiment, possibly in combination with the former, whenever a new terminal address is inserted into a first list of addresses, a send code is associated with it in this first list of addresses.

The new address is then also inserted into the other list of addresses with a send code identical with the one which is associated with it in the first list of addresses, or with, for at least one of the other lists of addresses, a send code different from the one which is associated with it in the first list of addresses.

Optionally, the number of duplications of the list of addresses is parameterizable.

The invention according to a second aspect, also relates to a system for sending messages into a communications network by electronic messaging which applies the method of the invention as explained above.

Finally, the invention according to a third aspect, relates to a storage medium legible by a terminal, on which is stored a sequence of instructions which, when executed by a computer system, allows this computer system to apply the method of the invention as described above.

Thus, advantageously, with the method and system of the invention, it is possible to block the sending of bulk messages to all the users of an address book by a malicious piece of software or virus. Indeed, such a virus, unaware of the existence of duplicated address lists will use the list of addresses or the standard address book for proceeding. It will then inevitably use a wrong send code for at least one of the addresses contained in the address book. The system will then detect the malicious operation and will block the sending of messages and will possibly inform the user.

Other features and advantages of the invention will become more apparent and complete upon reading the description hereafter of preferred alternative embodiments of the device, which are given as non-limiting examples and with reference to the following appended drawings.

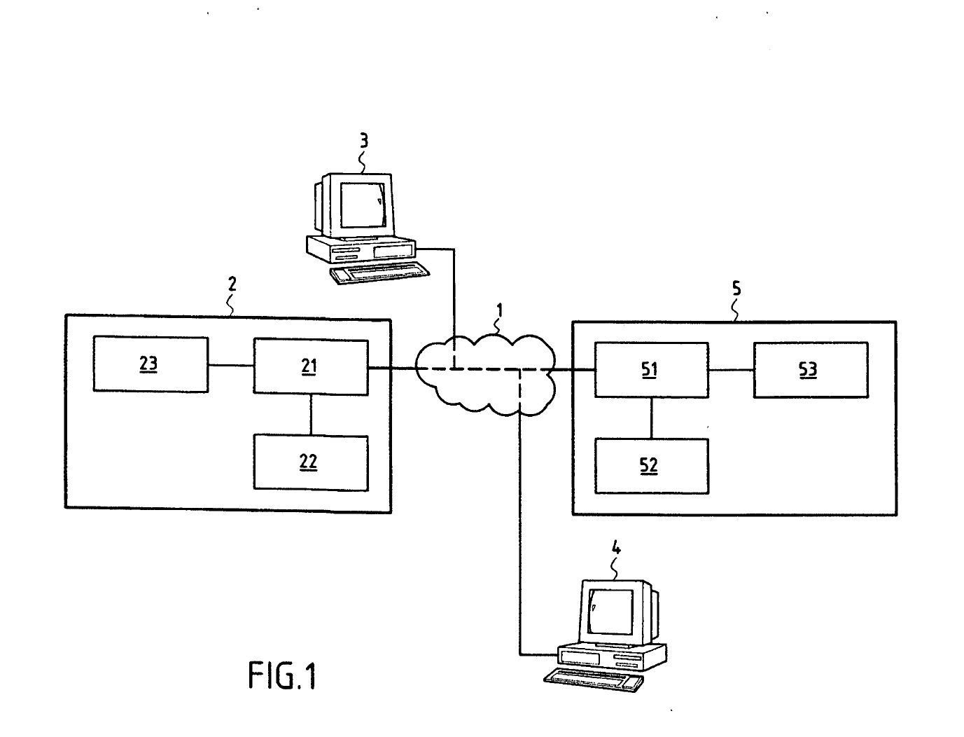

FIG. 1 schematically illustrates a system for sending electronic messages according to the invention,

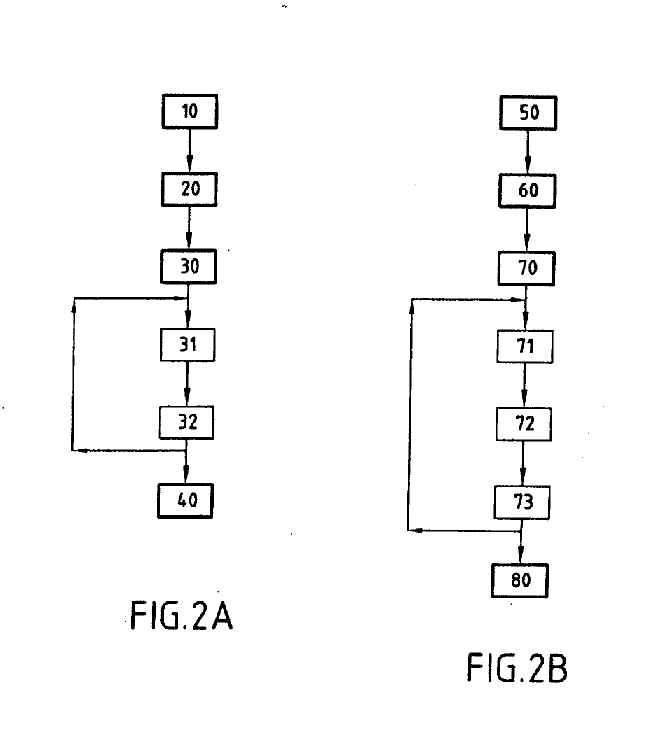

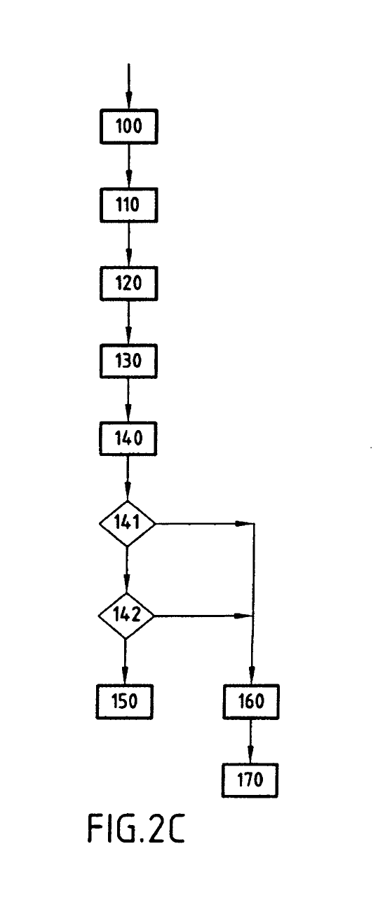

FIGS. 2a, 2b, 2c schematically represent the method for sending electronic messages according to the invention.

FIG. 1 schematically illustrates a system for sending electronic messages according to the invention, in which a first access server 2 allowing a first terminal 3 to access the communications network 1 and a second access server 5 allowing a second terminal 4 to access the communications network 1 are found. The communications network 1 is for example Internet.

By terminal, it is meant any terminal allowing the sending and receiving of electronic mails. For example, this may be a computer, as schematized in FIG. 1, or even an electronic personal assistant, a terminal with limited functions, entirely dedicated to electronic messaging, a portable telephone supporting electronic messaging functions. Generally, any electronic device supporting the functions of electronic messaging capable of connecting to the communications network 1, through a wired path (a telephone line for example) or through a wireless path (GSM for example) is suitable.

The access server 2 may comprise a processor 21, an area 22 for storing information, or a memory 22, or a module 23 for managing sent or received messages, the whole allowing the method of the invention to be applied, as it will be described later on with reference to FIGS. 2a, 2b and 2c. The memory 22 may as well be a conventional structure with simple or multiple registers or even a database. This description of a portion of the access server 2 is purely functional, and non-structural. Indeed, the memory 22 may very well be structurally integrated into the processor 21, or into the module 23 for example. Also, the module 23 and the processor 22 may only form a single entity.

The access server 5, as for it, may comprise a processor 51, an area 52 for storing information, or a memory 52, or a module 53 for managing sent or received messages. The memory 52 may as well be a conventional structure with simple or multiple registers or even a database. This description of a portion of the access server 5 is also purely functional, and non-structural. Indeed, the memory 52 may very well be structurally integrated into the processor 51, or into the module 53 for example. Also, the module 53 and the processor 52 may only form a single entity.

This access server 5 therefore allows the terminal 4 to access the communications network 1. It notably allows this terminal 4 to receive messages sent by the terminal 3 via the access server 2. However, it should be noted that the distinction between both access servers 4 and 5 is given by way of example and therefore does not limit the invention. Indeed, an access server generally allowing several terminals to access a communications network, the terminals 3 and 4 may very well access this communications network 1 via the same access server 2. The latter then alternatively plays the role of a sender access server when one of the terminals makes use of it for sending a message to the other one, and of an addressee access server when either one of the terminals makes use of it for receiving a message sent by the other one.

The method of the invention will now be described with reference to FIGS. 2a, 2b and 2c.

FIG. 2a describes the part of the method of the invention concerning the configuration and duplication of the lists of addresses.

In step 10, a send code is assigned to each address contained in the initial list of addresses. These send codes may be assigned automatically by the system, by a random generator for example, or manually by the user. This initial list of addresses may be stored at terminal 3 or even in the memory 22 of the sender access server 2. Also, this initial list of addresses may be partly stored at terminal 3 and partly stored in the memory 22 of the sender access server 2.

This operation may be performed at a local level, i.e., on terminal 3, with suitable messaging software if the operation is automated, or at the access server 2, via the module 23 and/or the processor 21 if the operation is automated, and this regardless of the place where this list of addresses is stored.

In step 20, the initial list of addresses is duplicated at least once, manually or automatically. Ideally, it is duplicated more than twice, in order to make the system more efficient. Preferably, the number N of duplications is parameterizable by the user. These duplicated lists of addresses may be stored at terminal 3 or even in the memory 22 of the sender access server 2. Also, these duplicated lists of addresses may be partly stored at terminal 3 and partly stored in the memory 22 of the sender access server 2.

Also, this operation may be achieved at a local level, i.e., on terminal 3, with suitable messaging software if the operation is automated, or at the access server 2, via module 23 and/or processor 21 if the operation is automated, and this regardless of the location where this list of addresses is stored.

In step 30, a loop over all the list of addresses starts, during which the latter will all be changed in order to contain at least one address for which the send code is wrong.

Ideally, each list of addresses will contain several addresses for which the same code is wrong. The number of its addresses with a wrong send code depends on the number of total addresses and on the number of lists of addresses. It may be calculated by the system automatically, or even be parameterized manually.

The loop therefore repeats steps 31 and 32 for all the lists of addresses. In step 31, at least one send code, associated with an address Am, in the list of addresses Ln, is changed in order to make it wrong. In step 32, the information according to which the send code associated with the address Am in the list of addresses Ln is wrong, is archived, preferably with encryption. This archiving may be found at terminal 3, or at the memory 22 of the sender access server 2, or even distributed both on the terminal 3 and in the memory 22 of the sender access server 2. Alternatively, the archived information may also be the complementary information of the former, i.e., the fact that the same code associated with a given address is correct in a certain number of lists of given addresses.

Step 40 symbolizes the end of part of the method of the invention which concerns the configuration and duplication of the lists of addresses.

FIG. 2b describes the part of the method of the invention which concerns the insertion of a new address into the set of available addresses for sending messages.

In step 50, a new address is therefore inserted automatically or manually into any of the lists of addresses. In step 60, a send code is assigned to it in this list of addresses, there again manually or automatically (via a random generator for example).

In step 70, a loop over all the lists of addresses starts, during which the latter will all be updated in order to include this new address.

The loop therefore repeats steps 71 to 73 for all the lists of addresses. In step 71, the new address Am is inserted into the list of addresses Ln. In step 72, a send code, generated either manually or automatically (for example randomly), is associated with the new address Am. This send code may be selected so as to be a wrong send code or not. The system decides according to the total number of lists of addresses and to the total number of addresses. In step 73, the information according to which the send code associated with the address Am in the list of addresses Ln is wrong, is archived, preferably with encryption. This archiving may be found at the terminal 3, or at the memory 22 of the sender access server 2, or even distributed both on the terminal 3 and the memory 22 of the sender access server 2. Alternatively, the archived information may also be complementary information of the former, i.e., the fact that the send code associated with a given address is correct in a certain number of lists of given addresses.

Step 80 symbolizes the end of the part of the method of the invention which concerns the insertion of a new address in the set of available addresses for sending messages.

FIG. 2c describes the sending of a message by the terminal 3 to the terminal 4 according to the method of the invention.

In step 100, a user of the terminal 3 connects to the electronic messaging system in order to send a message to the user of the terminal 4. This operation may be achieved at a local level with suitable messaging software installed on the sender terminal. It may also be achieved, from any terminal connected to the network, directly at the sender access server 2, typically by means of a so-called web mail service.

Step 110 corresponds to the selection of a list of addresses from the N lists of available addresses, in which the address of the addressee is found with its associated send code. The operation may be achieved manually, but preferably this operation is achieved by the system of the invention automatically which determines the list of addresses to be selected, depending on information archived in step 32 and/or in step 73.

This operation being achieved, step 120 is applied, during which the send code associated with the address of the addressee, which is found in the list of addresses selected previously, is inserted into the message. The insertion may occur into any location in the message, for example, but not necessarily in the subject field of the message.

Optionally, if the functionality has been provided and enabled in the system, a security code for example randomly and periodically set by the access server 2, is inserted into the message in step 130, the application of which is analogous to that of step 120. Preferably, this security code is stored with encryption on the sender terminal 3. As an example, with a validity period of the access code of one day, the method of the invention may provide that at each new connection of the sender terminal 3 to the network by means of its access server 2, the latter checks that the security code stored on the terminal is actually the security code of the day. If this is not the case, the access server discharges the new security code as a replacement for the previous one on the terminal.

In step 140, after having received the message sent by the sender terminal 3 if this sending was performed locally, the access server 2 proceeds with checking the validity of the message sent. Specifically, in step 141, the access server 2 checks whether the send code present in the message complies with the expected send code for the addressee of the message. This check may be based on archived data during steps 32 and/or 73. If the send code does not comply, step 141 is followed by step 160, during which the system blocks the message. This step 160 is itself followed by step 170 during which the access server 2 informs the user of terminal 3 of the blocking of the message. If, on the other hand, the code does comply, step 141 is followed by step 142 during which the access server 2 checks whether the security code present in the message complies with the expected security code (independent of the addressee). If this security code does not comply, step 142 is followed by steps 160 and 170 described above. Otherwise, i.e., if the security code does comply, the access server 2 proceeds with sending of the message in a conventional way (step 150).

Thus, advantageously with the method and system of the invention it is possible to block the sending of bulk messages to all the users of an address book by a malicious piece of software or virus. Indeed, such a virus unaware of the existence of duplicated address lists will use the list of addresses or the standard book of addresses in order to proceed. Even if it knows the structure of the list of addresses with the presence of send codes, it will then inevitably use a wrong send code for at least one of the addresses contained in the book of addresses. The system will then detect the malicious operation and will block the sending of messages and will possibly inform the user.

It is recalled that the whole of the description above is of course given as an example and does not limit the invention. In particular, the presence of two distinct access servers, one being the sender 2 and the other the addressee 5, is not limitative of the invention, since the sender user and the addressee user may very well use the same access server for accessing the network.

Moreover, it will be recalled that the use of terminals for connecting to the network is also not a limitation of the invention. Indeed, it is meant by the term terminal, any terminal with which it is possible to send and receive electronic messages. For example, this may be a simple computer or even an electronic personal assistant, a terminal with limited functions, completely dedicated to the electronic messaging system, a portable telephone supporting electronic messaging functions. Generally, any electronic device supporting electronic messaging functions, capable of connecting to the communications network, through a wired route (for example a telephone line) or a wireless route (for example GSM), may be suitable.

In addition, a same terminal may be used by the sender user on the one hand, and the addressee user on the other hand, playing in turn the role of a sender terminal which connects to the network via a sender access server and that of an addressee terminal which connects to the server via an addressee access server, the latter able to be the same as the sender access server as specified above.

1. A method for sending messages into a communications network by electronic messaging including at least one access server used by at least one sender terminal in order to connect to said communications network, said sender terminal having access to at least one list of addresses of terminals, said method comprising:
a configuration step during which a send code is associated with each terminal address contained in said list of addresses,
a duplication step during which said list of addresses is duplicated at least once,
a modification step during which each list of addresses is changed in order to contain at least one wrong send code,
a step for selecting, during the sending of a message to an addressee terminal, a list of addresses from said lists of addresses,
a step for inserting into said message, said send code associated with the address of said addressee terminal in said selected list of addresses,
a step for checking compliance of said send code inserted into said message.

2. The method according to claim 1, wherein said terminal has access to at least one security code, said method further comprises:
a step for inserting said security code into said message,
a step for checking compliance of said security code inserted into said message.

3. The method according to claim 2, wherein said security code is set by said access server randomly and periodically.

4. The method according to claim 1, wherein said steps for checking said send code and/or said security code, are performed by said access server.

5. The method according to claim 4, wherein when any of said checking steps gives a non-compliant result, said access server informs said sender terminal about it and/or blocks the sending of said message.

6. The method according to claim 1, wherein whenever a new terminal address is inserted into a first list of said list of addresses, a send code is associated with it in this said first list of addresses.

7. The method according to claim 6, wherein said new address is also inserted in the other lists of addresses with a send code identical with the one which is associated with it in said first list of addresses.

8. The method according to claim 6, wherein said new address is also inserted in the other list of addresses with, for at least one of said other address lists, a send code different from the one which is associated with it in said first list of addresses.

9. The method according to claim 1, wherein the number of said duplications of said list of addresses is parameterizable.

10. A system for sending messages into a communications network by electronic messaging, applying the method according to any of claim 1.

11. A storage medium legible by a terminal, on which a sequence of instructions is stored, which, when it is executed by a computer system, allows said computer system to apply the method according to claim 1.
